(19) United States
(12) Patent Application Publication
(10) Pub. No.: US 2026/0180066 A1
(43) Pub. Date: Jun. 25, 2026

(54) BATTERY PACK AND LOWER CASE

(71) Applicant: TOYOTA BATTERY CO., LTD., Kosai-shi (JP)

(72) Inventor: Yuji KATAYAMA, Okazaki-shi (JP)

(21) Appl. No.: 19/429,856

(22) Filed: Dec. 22, 2025

(30) Foreign Application Priority Data
Dec. 23, 2024 (JP) 2024-226690

(51) Int. Cl. H01M 10/653; H01M 10/613; H01M 10/6554; H01M 50/209; H01M 50/227; H01M 50/289; H01M 50/553

(52) U.S. Cl. CPC H01M 10/653; H01M 10/613; H01M 10/6554; H01M 50/209; H01M 50/227; H01M 50/289; H01M 50/553

(57) ABSTRACT

An aspect of a battery pack according to the present disclosure is a battery pack including: a pond structure part in which a plurality of walls are formed so as to surround an area where the top surface of the heat dissipation projection is exposed is formed at a position corresponding to an electrode component attached to the battery cell, and the pond structure part is filled with a thermally conductive agent, the passage is formed so as to extend in the row direction in an area adjacent to the plurality of thermally conductive agent filling parts, and a thermally conductive agent amount control wall that faces the passage is formed in such a way that a height of the thermally conductive agent amount control wall is the lowest of the plurality of walls in each of the plurality of thermally conductive agent filling parts.

### INCORPORATION BY REFERENCE

This application is based upon and claims the benefit of priority from Japanese patent application No. 2024-226690, filed on Dec. 23, 2024, the disclosure of which is incorporated herein in its entirety by reference for all purposes.

### BACKGROUND

The present disclosure relates to, for example, a battery pack and a lower case in which a plurality of battery cells are housed.

With the improvement in performance of a battery, it has become a problem how to ensure the heat dissipation of the battery. Japanese Unexamined Patent Application Publication No. 2024-50379 discloses a technique related to heat dissipation of a battery pack housing a plurality of battery cells.

The battery pack disclosed in Japanese Unexamined Patent Application Publication No. 2024-50379 includes: a plurality of secondary batteries, each of which includes an external terminal on a bottom thereof; a bus bar assembly including a connection substrate for electrically connecting the external terminals of the respective secondary batteries and conducting heat from the external terminals; a case in which the bus bar assembly is disposed on the bottom and the plurality of the secondary batteries are connected to the bus bar assembly in an aligned state and housed; and a heat dissipation member which is disposed outside the case and dissipates heat from the connection substrate to the outside of the case.

### SUMMARY

In the battery pack disclosed in Japanese Unexamined Patent Application Publication No. 2024-50379, a thermally conductive agent is applied to increase the thermal conductivity between the bus bar assembly and the heat dissipation member. However, the technique disclosed in Japanese Unexamined Patent Application Publication No. 2024-50379 causes a problem that the direction in which the applied thermally conductive agent flows out when the bus bar assembly is pressed against the heat dissipation member cannot be controlled.

The present disclosure has been made in view of the above-described circumstances, and an object thereof is to control the direction in which a thermally conductive agent flows out when an electrode component attached to a battery cell is pressed against a heat dissipation member.

An aspect of a battery pack according to the present disclosure is a battery pack including: a plurality of battery cells; a battery housing part configured to house the plurality of battery cells; and a heat dissipation plate disposed in such a way that a heat dissipation surface is exposed to an outside of the battery housing part, in which a plurality of thermally conductive agent filling parts and a passage are formed in a bottom surface of the battery housing part, in each of the plurality of thermally conductive agent filling parts formed side by side in a row direction in which the battery cells are stacked, a top surface of a heat dissipation projection formed on a rear side of the heat dissipation surface is exposed, a pond structure part in which a plurality of walls are formed so as to surround an area where the top surface of the heat dissipation projection is exposed is formed at a position corresponding to an electrode component attached to the battery cell, and the pond structure part is filled with a thermally conductive agent, the passage is formed so as to extend in the row direction in an area adjacent to the plurality of thermally conductive agent filling parts, and a thermally conductive agent amount control wall that faces the passage is formed in such a way that a height of the thermally conductive agent amount control wall is the lowest of the plurality of walls in each of the plurality of thermally conductive agent filling parts.

An aspect of a lower case according to the present disclosure is a lower case of a battery pack in which a plurality of battery cells are housed, the lower case including: a battery housing part configured to house the plurality of battery cells; and a heat dissipation plate disposed in such a way that a heat dissipation surface is exposed to an outside of the battery housing part, in which a plurality of thermally conductive agent filling parts and a passage are formed in a bottom surface of the battery housing part, in each of the plurality of thermally conductive agent filling parts formed side by side in a row direction in which the battery cells are stacked, a top surface of a heat dissipation projection formed on a rear side of the heat dissipation surface is exposed, a pond structure part in which a plurality of walls are formed so as to surround an area where the top surface of the heat dissipation projection is exposed is formed at a position corresponding to an electrode component attached to the battery cell, and the pond structure part is filled with a thermally conductive agent, the passage is formed so as to extend in the row direction in an area adjacent to the plurality of thermally conductive agent filling parts, and a thermally conductive agent amount control wall that faces the passage is formed in such a way that a height of the thermally conductive agent amount control wall is the lowest of the plurality of walls in each of the plurality of thermally conductive agent filling parts.

By the battery pack and the lower case according to the present disclosure, it is possible to control the direction in which a thermally conductive agent flows out when an electrode component attached to a battery cell is pressed against a heat dissipation member.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram of a battery pack according to a first embodiment;

FIG. 2 is a schematic diagram of a heat dissipation plate according to the first embodiment;

FIG. 3 is a schematic diagram of a lower case according to the first embodiment;

FIG. 4 is an enlarged view of a thermally conductive agent filling part according to the first embodiment;

FIG. 5 is a cross-sectional view of the battery pack taken along a line V-V of FIG. 1;

FIG. 6 is a cross-sectional view of the battery pack taken along a line VI-VI of FIG. 1;

FIG. 7 is a cross-sectional view of the battery pack taken along a line VII-VII of FIG. 1; and

FIG. 8 is a diagram for explaining examples in which battery cells are housed when L-shaped electrode terminals are used.

### DESCRIPTION OF EMBODIMENTS

For the clarification of the description, the following descriptions and the drawings are partially omitted and simplified as appropriate. Note that the same elements are denoted by the same reference numerals or symbols throughout the drawings, and redundant descriptions are omitted as necessary.

### First Embodiment

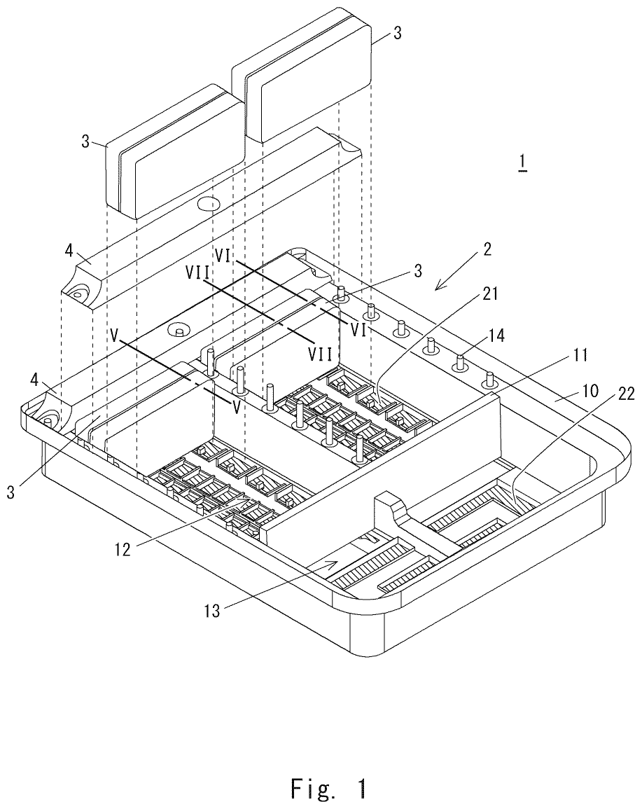

FIG. 1 is a schematic diagram of a battery pack according to a first embodiment. As shown in FIG. 1, in a battery pack 1 according to the first embodiment, a plurality of battery cells 3 are housed in a lower case 2, and the housed battery cells 3 are pressed against a bottom surface of the lower case 2 by vibration suppression plates 4, so that the battery cells 3 are fixed in the lower case 2. FIG. 1 shows bolts 14 used for fixing the vibration suppression plates 4 to the lower case 2.

In FIG. 1, in order to explain a state in which the battery cells 3 are housed in the lower case 2, two of the battery cells 3 are housed in the lower case 2 as one set. However, the battery cells 3 housed in the lower case 2 are assembled in the shape of a battery stack in which one row of the battery cells 3 (14 of the battery cells 3 in the example shown in FIG. 1) are connected by bus bar components and then housed in the lower case 2 for each battery stack. Further, FIG. 1 shows an example in which two battery stacks are housed in two rows in one lower case 2. However, the number of rows of the battery stacks housed in the lower case 2 can be changed in accordance with the specifications of the battery pack 1 as appropriate. In the following description, the direction in which the battery cells 3 are stacked is referred to as a row direction, and the direction in which the battery stacks are arranged is referred to as a column direction, and the column direction is a direction orthogonal to the row direction.

The lower case 2 is composed of a lower case tab 10 formed by integrally molding a heat dissipation plate 20, which will be described later as an insert component, and resin. The heat dissipation plate 20 is disposed in the lower case tab 10 in such a way that a heat dissipation surface is exposed to the outside of a battery housing part. Further, the inside of the lower case tab 10 is separated into a battery housing part 12 and a junction box housing part 13 by providing a partition wall 11 in the lower case tab 10. A plurality of the battery cells 3 are housed in the battery housing part 12. Further, a junction box, which is a circuit for inputting and outputting electric power of the plurality of the battery cells 3, is disposed in the junction box housing part 13. In FIG. 1, the junction box itself is omitted. In the bottom of the junction box housing part 13, a top surface of a heat dissipation projection 22 formed on the rear side of the heat dissipation surface of the heat dissipation plate 20 is exposed, a pond structure part in which a plurality of walls are formed so as to surround an area where the top surface of the heat dissipation projection 22 is exposed is formed at a position corresponding to an electrode component of the junction box, and the pond structure part is filled with a thermally conductive agent.

Further, as shown in FIG. 1, a plurality of thermally conductive agent filling parts and a passage are formed in the bottom surface of the battery housing part 12. In each of the plurality of thermally conductive agent filling parts formed side by side in the row direction in which the battery cells are stacked, a top surface of a heat dissipation projection 21 formed on the rear side of the heat dissipation surface of the heat dissipation plate 20 is exposed, a pond structure part in which a plurality of walls are formed so as to surround an area where the top surface of the heat dissipation projection 21 is exposed is formed at a position corresponding to an electrode component attached to the battery cell 3, and the pond structure part is filled with a thermally conductive agent. The passage is formed so as to extend in the row direction in an area adjacent to the plurality of thermally conductive agent filling parts. The structure of the thermally conductive agent filling part will be described in detail below.

Note that adhesion between the thermally conductive agent and the heat dissipation projection 21 and the electrode of the battery cell 3 is important, and in order to ensure insulation, and a material obtained by adding an inorganic filler having a high thermal conductivity to resin may be employed. For example, a material obtained by adding an inorganic filler to resin containing silicone resin (polyalkylsiloxane) as a main component may be employed. Alternatively, a material obtained by adding an inorganic filler to resin containing a liquid crystal polymer as a main component may be employed. Alternatively, a material obtained by adding an inorganic filler to resin containing acrylic resin as a main component may be employed. As described above, a material of the thermally conductive agent is selected or combined by taking into account the thermal conductivity, strength, insulation, and the like.

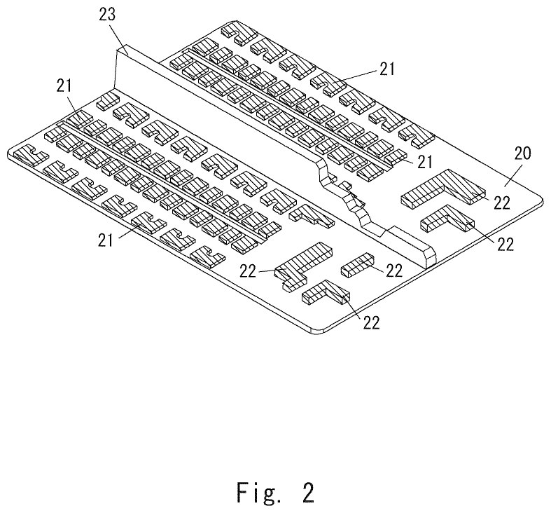

FIG. 2 is a schematic diagram of the heat dissipation plate 20 according to the first embodiment. As shown in FIG. 2, a plurality of the heat dissipation projections 21 are formed in the heat dissipation plate 20 at positions corresponding to electrode components attached to the battery cells 3. Further, in the example shown in FIG. 2, a column isolation wall 23 that divides rows of the battery stacks is formed. Further, in the example shown in FIG. 2, the heat dissipation projections 22 are formed in an area corresponding to the junction box.

Note that the size of the heat dissipation plate 20 is not limited to a size corresponding to the size of the battery housing part 12, and by making the size the heat dissipation plate 20 correspond to both the size of the battery housing part 12 and the size of the junction box housing part 13, it is possible to enhance not only the heat dissipation force for the battery cell but also the heat dissipation force for the junction box. The lower case tab 10 is formed of resin in which the above heat dissipation plate 20 is integrated.

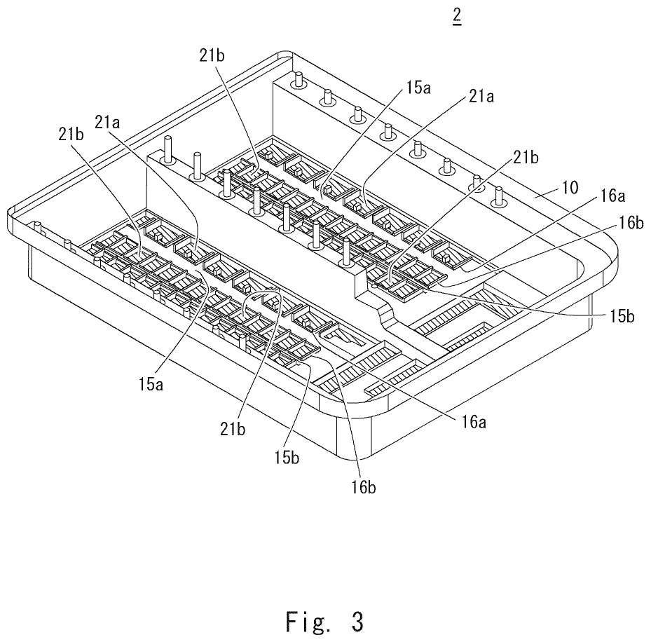

FIG. 3 is a schematic diagram of the lower case 2 according to the first embodiment. As shown in FIG. 3, regarding the heat dissipation plate 20, the plurality of thermally conductive agent filling parts are formed in the area of the battery housing part 12 in the bottom surface of the lower case tab 10, in which top surfaces of the heat dissipation projections 21 are exposed, a pond structure part in which a plurality of walls are formed so as to surround an area where the top surfaces of the heat dissipation projections 21 are exposed is formed at a position corresponding to an electrode component attached to the battery cell 3, the pond structure part is filled with a thermally conductive agent, and the plurality of thermally conductive agent filling parts are disposed side by side in the row direction in which the battery cells are stacked. The passage is formed so as to extend in the row direction in an area adjacent to the plurality of thermally conductive agent filling parts.

Note that the battery cell 3 according to the first embodiment has a two-cell structure in which two electrode bodies are housed in one case. Therefore, the battery cell 3 includes an intermediate terminal cover which covers an intermediate terminal connecting the two electrode bodies housed in the one case to each other in addition to the positive electrode terminal and the negative electrode terminal. This intermediate terminal cover is formed of, for example, an insulating metal having a higher thermal conductivity than that of resin. Therefore, as shown in FIG. 3, in the lower case 2 according to the first embodiment, as the plurality of thermally conductive agent filling parts, a first thermally conductive agent filling part 16a and a second thermally conductive agent filling part 16b are formed. The first thermally conductive agent filling part 16a has a pond structure part having a shape that matches the shape of a bus bar component connecting adjacent electrodes of different polarities among a plurality of battery cells to each other. The second thermally conductive agent filling part 16b has a pond structure part having a shape that matches the shape of the intermediate terminal cover which covers the intermediate terminal connecting the two electrode bodies housed in the one case to each other. In FIG. 3, the heat dissipation projection 21 exposed in the first thermally conductive agent filling part 16a is denoted by a reference symbol of 21a, while the heat dissipation projection 21 exposed in the second thermally conductive agent filling part 16b is denoted by a reference symbol of 21b.

Further, as shown in FIG. 3, in the battery housing part 12, passages 15a and 15b are formed so as to extend in the row direction in areas adjacent to the plurality of thermally conductive agent filling parts. In the example shown in FIG. 3, the passage 15a is formed between the first thermally conductive agent filling part 16a and the second thermally conductive agent filling part 16b, and the passage 15b is formed between the second thermally conductive agent filling parts 16b formed in a divided manner. In the lower case 2 according to the first embodiment, the direction in which the thermally conductive agent flows out is controlled by the structures of walls surrounding the heat dissipation projections in the first thermally conductive agent filling part 16a and the second thermally conductive agent filling part 16b.

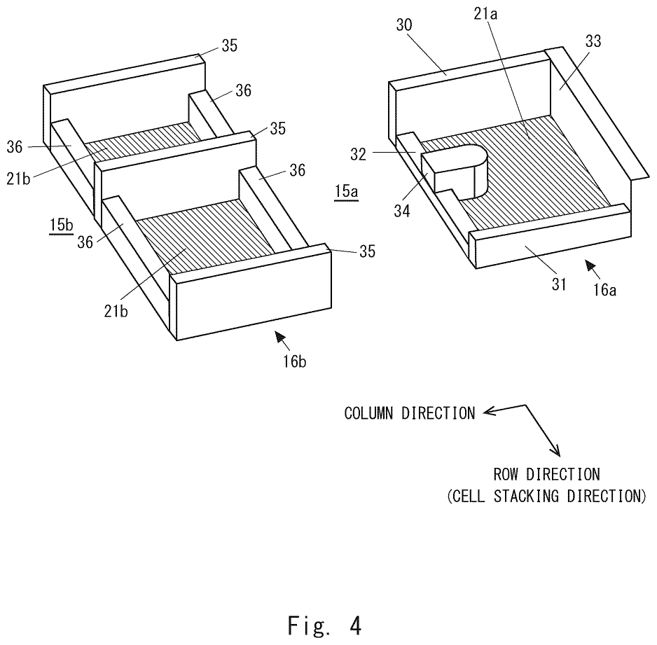

FIG. 4 is an enlarged view of the thermally conductive agent filling part according to the first embodiment. As shown in FIG. 4, the first thermally conductive agent filling part 16a in which the heat dissipation projection 21a is surrounded by walls includes a first wall 30, a second wall 31, a thermally conductive agent amount control wall 32, and a case side wall 33 so that they surround the exposed top surface of the heat dissipation projection 21a. Further, FIG. 4 shows a positioning projection 34 at a position in contact with the thermally conductive agent amount control wall 32. The positioning projection 34 is a projection for determining the position of the case side wall 33. That is, the first thermally conductive agent filling part has a shape of the pond structure part that matches the shape of a bus bar component.

As shown in FIG. 4, in the first thermally conductive agent filling part 16a, the first wall 30 and the second wall 31 disposed at positions where they face each other in the row direction are formed. Further, in the first thermally conductive agent filling part 16a, the thermally conductive agent amount control wall 32 and the case side wall 33 are disposed at positions where they face each other in the row direction. Further, the thermally conductive agent amount control wall 32 is formed at a position where it faces the passage 15a. Further, in the example shown in FIG. 4, the height of the first wall 30 is set to be the highest, the height of the thermally conductive agent amount control wall 32 is set to be the lowest, and the height of the second wall 31 is set to be an intermediate height between the height of the first wall 30 and the height of the thermally conductive agent amount control wall 32. By setting the heights of the walls as described above, regarding the thermally conductive agent filled in the first thermally conductive agent filling part 16a so as to cover the top surface of the heat dissipation projection 21a, the thermally conductive agent that overflows when the bus bar component of the battery cell 3 is pressed flows over the thermally conductive agent amount control wall 32 and into the passage 15a. Further, by setting the height of the second wall 31 to be lower than the height of the first wall 30, the wiring (e.g., flexible printed wiring) and the like which are connected to a voltage detecting element connected to the bus bar component and the like can be easily drawn out into the passage 15a.

Further, in the second thermally conductive agent filling part 16b, the size of each of the spaces in the row direction is defined by a plurality of third walls 35 disposed in the row direction, and two fourth walls 36 are formed so that they face each other in the column direction. Further, the height of the fourth wall 36 is set to be lower than that of the third wall 35. As a result, in the second thermally conductive agent filling part 16b, the thermally conductive agent that overflows when the intermediate terminal cover of the battery cell 3 is pressed flows over the fourth walls 36 and flows into the passage 15a or the passage 15b provided in the area that faces the passage 15a across the second thermally conductive agent filling part 16b. Note that the width of the second thermally conductive agent filling part 16b in the row direction may be any width that matches the shape of the periphery of the intermediate terminal cover of the battery cell 3, and does not need to be fixed.

In the passage 15b, flexible printed wiring (FPC) is disposed between the second thermally conductive agent filling parts 16b adjacent to each other in the column direction. By having a structure in which the flexible printed wiring can be disposed at such a position, in the battery pack 1, the passage 15b is disposed at the center of each of the battery housing parts 12 partitioned by the column isolation wall 23 in the column direction, and the lengths of the battery cells 3 in the column direction can be unified in the battery stack. Further, the flexible printed wiring is connected to a temperature measuring circuit, and is used to measure the temperature in the case.

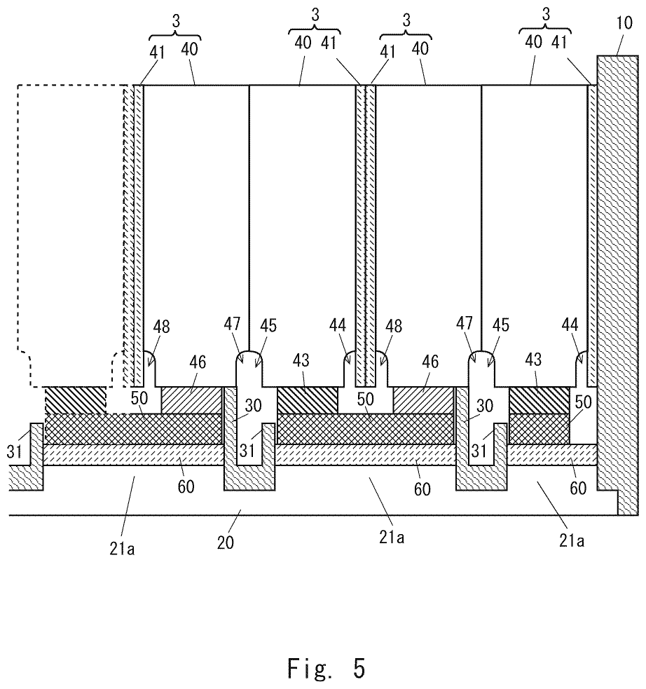

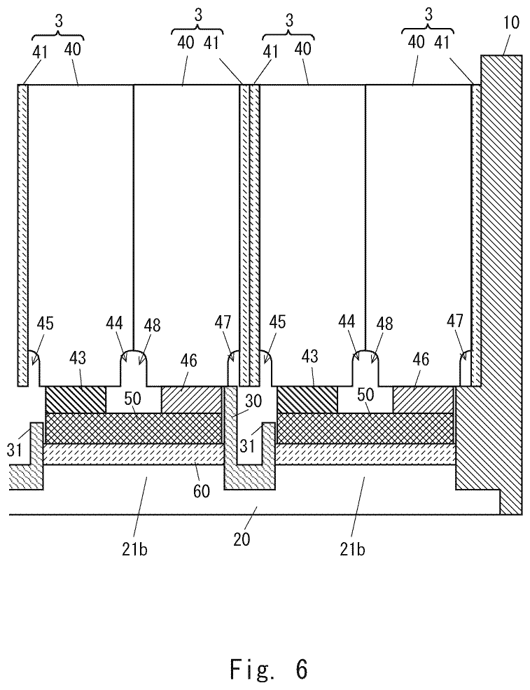

Next, a cross-sectional structure of the first thermally conductive agent filling part 16a will be described. FIG. 5 shows a cross-sectional view of the battery pack 1 taken along a line V-V of FIG. 1, while FIG. 6 shows a cross-sectional view of the battery pack 1 taken along a line VI-VI of FIG. 1. Note that each of FIGS. 5 and 6 shows a cross-sectional view of a state in which the battery cells 3 are housed in the lower case 2. As shown in FIGS. 5 and 6, in the first thermally conductive agent filling part 16a in a state in which it is filled with a thermally conductive agent 60, the battery cells 3 are housed in the lower case 2 so that bus bar components 50 are housed. At this time, electrodes of different polarities of the battery cells 3 are alternately arranged in the battery stack. Therefore, it is necessary to make a distance (creepage distance) between the surfaces connecting the electrodes of different polarities equal to or greater than a predetermined insulation distance in view of safety. Considering this creepage distance, the presence of the first wall 30 and the second wall 31 makes it possible to make the creepage distance larger than the distance between the electrodes of the battery cell 3 in the horizontal direction (e.g., the horizontal direction in the drawing).

Further, as shown in FIGS. 5 and 6, the battery cell 3 is composed of a cell case 40 and a cell case lid 41. Further, in each of the cell cases 40 of a plurality of the battery cells 3, recesses (e.g., recesses 44 and 45 and recesses 47 and 48) are provided on the respective sides of the parts of a positive electrode terminal 43 and a negative electrode terminal 46 adjacent to each other in the row direction in the cell lower case in which the electrode bodies are housed. The above recesses may be provided in at least one of the parts adjacent to the positive electrode terminal 43 and the negative electrode terminal 46 in the row direction. The presence of the recesses makes it possible to make the creepage distance along the surfaces of the cell case 40 and the cell case lid 41 larger than the distance between the electrodes of the battery cell 3 in the horizontal direction.

By providing the first wall 30 and the second wall 31 and the recesses 44, 45, 47, and 48 of the first thermally conductive agent filling part 16a as described above, it is possible to make the creepage distance larger than the distance between the electrodes of the battery cell 3 in the horizontal direction. That is, by providing the first wall 30 and the second wall 31 and the recesses 44, 45, 47, and 48 of the first thermally conductive agent filling part 16a, it is possible to, in the battery pack 1 according to the first embodiment, house the battery cells 3 with higher density and reduce the volume of the battery pack 1 while securing an appropriate insulation distance.

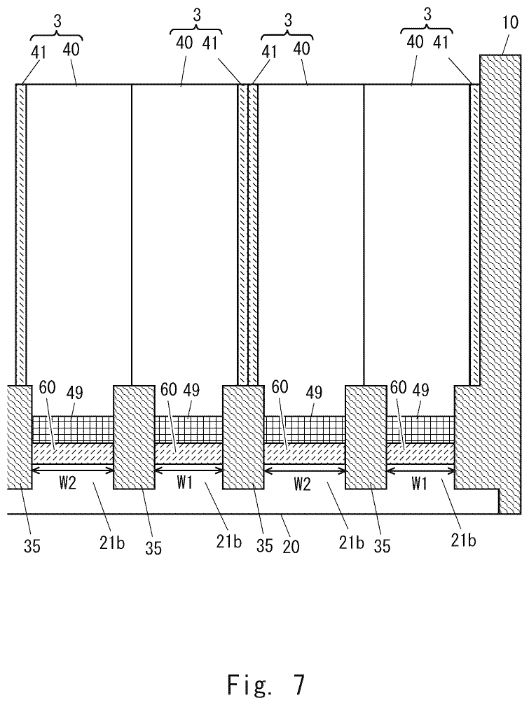

Next, a cross-sectional structure of the second thermally conductive agent filling part 16b will be described. FIG. 7 is a cross-sectional view of the battery pack 1 taken along a line VII-VII of FIG. 1. As shown in FIG. 7, in the lower case 2 according to the first embodiment, the battery cells 3 are housed so that intermediate terminal covers 49 of the battery cells 3 fit into the second thermally conductive agent filling part 16b filled with the thermally conductive agent 60. At this time, in the lower case 2, the presence of the third walls 35 makes it possible to make the insulation distance between the intermediate terminals of the battery cell 3 larger than the distance between the electrodes of the battery cell 3 in the horizontal direction. Further, in the example shown in FIG. 7, the second thermally conductive agent filling part 16b having a length W1 in the row direction and the second thermally conductive agent filling part 16b having a length W2 larger than W1 in the row direction are alternately arranged. This is because the cell case 40 is formed in such a way that the width of the positive electrode terminal part and the width of the negative electrode terminal part connected to the intermediate terminal differs from each other.

As described above, in the battery pack 1 according to the first embodiment, by setting the height of the thermally conductive agent amount control wall 32 or the fourth wall 36 that faces the passages 15a and 15b to be the lowest of the walls surrounding the part of the thermally conductive agent filling part where the top surface of the heat dissipation projection is exposed, the thermally conductive agent filled in the thermally conductive agent filling part can optionally overflow into the area (e.g., the passages 15a and 15b) disposed in the column direction of each of the thermally conductive agent filling parts. Thus, in the battery pack 1, by the overflowed thermally conductive agent, the creepage distance between the battery cells 3 arranged in the row direction can be made larger than the distance between the electrodes of the battery cell 3 in the horizontal direction, and hence the battery cells 3 can be housed in the battery pack 1 with higher density.

Further, in the battery pack 1, the overflowed thermally conductive agent can be easily cleaned by overflowing the thermally conductive agent into the passages 15a and 15b.

Further, in the battery pack 1, by setting the height of the second wall 31 in the first thermally conductive agent filling part 16a to be an intermediate height between the first wall 30 and the thermally conductive agent amount control wall 32, it is possible to control the direction in which the thermally conductive agent overflows while securing a path for leading the wiring connected to the bus bar component.

Further, in the battery pack 1, by providing a thermally conductive agent filling part similar to that in the battery housing part 12 in the area of the junction box housing part 13, it is possible to secure the amount of heat dissipation through the bus bar components provided in the junction box and enhance the heat dissipation performance of the entire battery pack 1.

Further, in the battery cells 3 housed in the battery pack 1, by the recesses 44, 45, 47, and 48 provided on the respective sides of the positive electrode terminal 43 and the negative electrode terminal 46, the creepage distance along the surface of the cell case can be made larger than the distance between the electrodes of the battery cell 3 in the horizontal direction, and hence the battery cells 3 can be housed in the battery pack 1 with higher density.

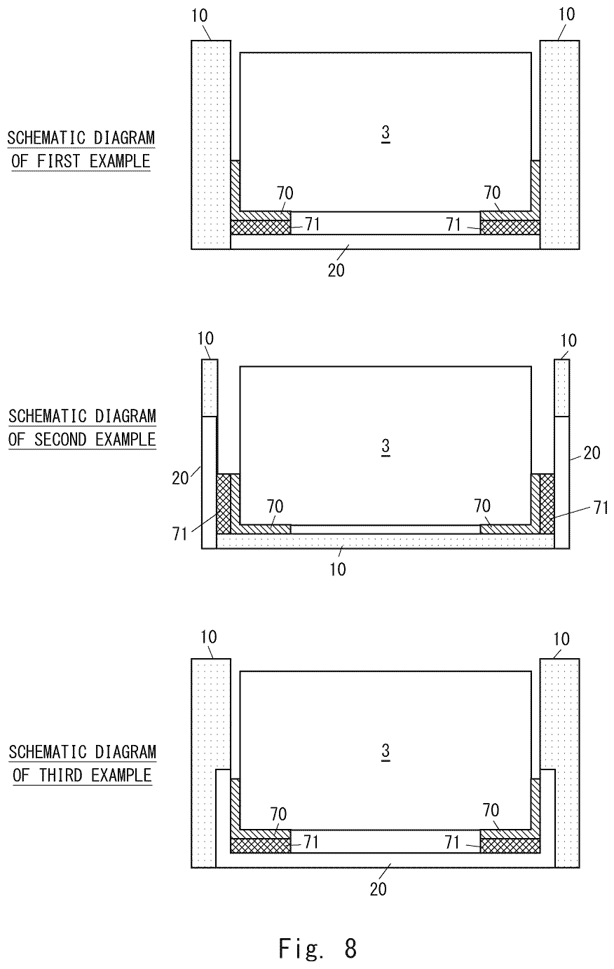

Further, the heat dissipation structure of the battery pack 1 can also be applied to the battery cell 3 including L-shaped electrode terminals formed over two consecutive surfaces. FIG. 8 shows a diagram for explaining examples in which the battery cells are housed when L-shaped electrode terminals are used. In the examples shown in FIG. 8, L-shaped electrode terminals 70 are housed in the lower cases 2 of various types through bus bar components 71. In a first example, a schematic diagram of the battery pack 1 in which the battery cells 3 including the L-shaped electrode terminals 70 are housed in the lower case 2 shown in FIG. 1 is shown. In a second example, a schematic diagram of the battery pack 1 in which the battery cells 3 including the L-shaped electrode terminals 70 are housed in the lower case 2 in which the heat dissipation plates 20 are disposed on the side walls is shown. This second example is effective in specifications in which restrictions in the height direction are stricter than those in the first example. In a third example, a schematic diagram of the battery pack 1 in which the battery cells 3 including the L-shaped electrode terminals 70 are housed in the lower case 2 including the heat dissipation plate 20 which covers both the bottom surface and the side walls is shown. The third example is effective in specifications requiring higher heat dissipation performance than that in the first example. By changing the arrangement or the shape of the heat dissipation plate 20 as described above, it is possible to configure the battery pack 1 in accordance with the vertical and horizontal sizes of the battery pack and the required heat dissipation performance.

Note that the present disclosure is not limited to the above-described embodiments and may be changed as appropriate without departing from the scope and sprit of the present disclosure.

What is claimed is:

1. A battery pack comprising:
a plurality of battery cells;
a battery housing part configured to house the plurality of battery cells; and
a heat dissipation plate disposed in such a way that a heat dissipation surface is exposed to an outside of the battery housing part,
wherein a plurality of thermally conductive agent filling parts and a passage are formed in a bottom surface of the battery housing part,
wherein, in each of the plurality of thermally conductive agent filling parts formed side by side in a row direction in which the battery cells are stacked, a top surface of a heat dissipation projection formed on a rear side of the heat dissipation surface is exposed, a pond structure part in which a plurality of walls are formed so as to surround an area where the top surface of the heat dissipation projection is exposed is formed at a position corresponding to an electrode component attached to the battery cell, and the pond structure part is filled with a thermally conductive agent,
wherein the passage is formed so as to extend in the row direction in an area adjacent to the plurality of thermally conductive agent filling parts, and
wherein a thermally conductive agent amount control wall that faces the passage is formed in such a way that a height of the thermally conductive agent amount control wall is the lowest of the plurality of walls in each of the plurality of thermally conductive agent filling parts.

2. The battery pack according to claim 1, wherein the battery housing part is formed of a resin member, and the heat dissipation plate is formed of a metal member.

3. The battery pack according to claim 1, wherein:
each of the battery cells has a two-cell structure in which two electrode bodies are housed in one case,
the plurality of thermally conductive agent filling parts comprises:
a first thermally conductive agent filling part comprising the pond structure part having a shape that matches a shape of a bus bar component connecting adjacent electrodes of different polarities among the plurality of battery cells to each other; and
a second thermally conductive agent filling part comprising the pond structure part having a shape that matches a shape of an intermediate terminal cover configured to cover an intermediate terminal connecting the two electrode bodies housed in the one case to each other, and
the first thermally conductive agent filling part and the second thermally conductive agent filling part are disposed in a column direction orthogonal to the row direction across the passage.

4. The battery pack according to claim 3, wherein:
the first thermally conductive agent filling part comprises a first wall and a second wall disposed at positions where they face each other in the row direction, and
the second wall is formed in such a way that a height of the second wall is lower than a height of the first wall and higher than the height of the thermally conductive agent amount control wall.

5. The battery pack according to claim 1, wherein in each of the plurality of battery cells, a recess is provided in at least one of a part of a positive electrode terminal and a part of a negative electrode terminal adjacent to each other in the row direction in a cell lower case in which the electrode bodies are housed.

6. A lower case of a battery pack in which a plurality of battery cells are housed, the lower case comprising:
a battery housing part configured to house the plurality of battery cells; and
a heat dissipation plate disposed in such a way that a heat dissipation surface is exposed to an outside of the battery housing part,
wherein a plurality of thermally conductive agent filling parts and a passage are formed in a bottom surface of the battery housing part,
wherein, in each of the plurality of thermally conductive agent filling parts formed side by side in a row direction in which the battery cells are stacked, a top surface of a heat dissipation projection formed on a rear side of the heat dissipation surface is exposed, a pond structure part in which a plurality of walls are formed so as to surround an area where the top surface of the heat dissipation projection is exposed is formed at a position corresponding to an electrode component attached to the battery cell, and the pond structure part is filled with a thermally conductive agent,
wherein the passage is formed so as to extend in the row direction in an area adjacent to the plurality of thermally conductive agent filling parts, and
wherein a thermally conductive agent amount control wall that faces the passage is formed in such a way that a height of the thermally conductive agent amount control wall is the lowest of the plurality of walls in each of the plurality of thermally conductive agent filling parts.
